(19) United States
(12) Patent Application Publication
(10) Pub. No.: US 2006/0002116 A1
(43) Pub. Date: Jan. 5, 2006

(54) Precipitation-proof vented lamp with stacked shades

(76) Inventor: Shih-Ming Lin, Hsiushui Hsiang (TW)

Correspondence Address: DELLETT AND WALTERS, P. O. BOX 2786, PORTLAND, OR, 97208-2786, US

(21) Appl. No.: 10/884,202

(22) Filed: Jul. 1, 2004

(51) Int. Cl. F21V 11/00

(52) U.S. Cl. 362/351; 362/414; 362/360

(57) ABSTRACT

A precipitation-proof vented lamp includes a base, an illuminating device mounted on the base and a stacked shade assembly. The stacked shade assembly is attached to the illuminating device and includes a primary shade, a connecting rod and a secondary shade. The primary shade is attached to the illuminating device and includes a shade casing and a mounting bracket. The shade casing has a minor opening with a minor annular edge in which the mounting bracket is mounted. The connecting rod is mounted on the mounting bracket and unites the primary and the secondary shades. The secondary shade has a major opening with a major annular edge overlapping the minor annular edge of the minor opening in the primary shade. The stacked shade assembly permits air ventilation to dissipate heat generated by the illuminating device yet prevents precipitation entering the outdoor light.

### BACKGROUND OF THE INVENTION

1. Field of the Invention

The present invention relates to an outdoor lamp, and more particularly to an outdoor precipitation-proof vented lamp with stacked shades that permit air ventilation to dissipate heat and prevent precipitation, such as rainwater entering the lamp.

2. Description of Related Art

Outdoor lights or lamps must be waterproof, because the combination of electricity and water is bad, which may cause injury through electrocution, danger from fire or inconvenience of resetting a fuse box. A conventional outdoor lamp generally has an illuminating device including a light bulb and an outside shade. The shade is made of waterproof materials and covers completely the light bulb to prevent precipitation, such as rainwater or melted snow entering the shade.

However, the light bulb inside the shade produces simultaneously heat and light beams, and the brighter the light, the higher temperature. The high temperature of the light bulb causes damage to the materials of the lamp due to the temperature difference between the hot interior and the cool exterior of the lamp. Therefore, the high temperature of the lamp will interfere with normal operations of the outdoor lamp and reduce a useful life of the light bulb. Therefore, the heat produced by the light bulb should be dissipated from the shade as quickly as possible.

Generally, the shade has multiple openings for ventilation so that the heat inside the shade can be dissipated through the openings. However, in such a configuration, the precipitation will easily enter the shade through the openings in the shade. The entered water may cause operations of electrical components of the outdoor lamp, such as circuits abnormally and damage the lamp.

Furthermore, the light bulb inside the lamp will need replacing due to its eventual failure yet it is found that to perform such replacement is problematic and irritating due to the difficulties in removing the shade from the lamp. For the conventional outdoor light, not only replacing the light bulb is inconvenient for users, but also assembling the light bulb with the shade is slow in the factories.

To overcome the shortcomings, the present invention provides a precipitation-proof vented lamp with stacked shades to mitigate or obviate the aforementioned problems.

### SUMMARY OF THE INVENTION

The main objective of the invention is to provide a precipitation-proof vented lamp using two stacked shades to prevent precipitation such as rainwater or melted snow from entering the lamp, and the stacked shades allow air ventilation to dissipate heat.

A precipitation-proof vented lamp in accordance with the present invention includes a base, an illuminating device mounted on the base and a stacked shade assembly. The stacked shade assembly is attached to the illuminating device and includes a primary shade, a connecting rod and a secondary shade. The primary shade is attached to the illuminating device and includes a shade casing and a mounting bracket. The shade casing has a minor opening with a minor annular edge in which the mounting bracket is mounted. The connecting rod is mounted on the mounting bracket and unites the primary and the secondary shades. The secondary shade has a major opening with a major annular edge overlapping the minor annular edge of the minor opening in the primary shade. The stacked shade assembly permits air ventilation to dissipate heat generated by the illuminating device and prevents precipitation such as rainwater entering the outdoor lamp.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a precipitation-proof vented lamp in accordance with the present invention;

FIG. 2 is a side elevational view in partial section of the precipitation-proof vented lamp in FIG. 1; and

FIG. 3 is an exploded perspective view of a stacked shade assembly of the outdoor light in FIG. 1.

### DETAILED DESCRIPTION OF PREFERRED EMBODIMENT

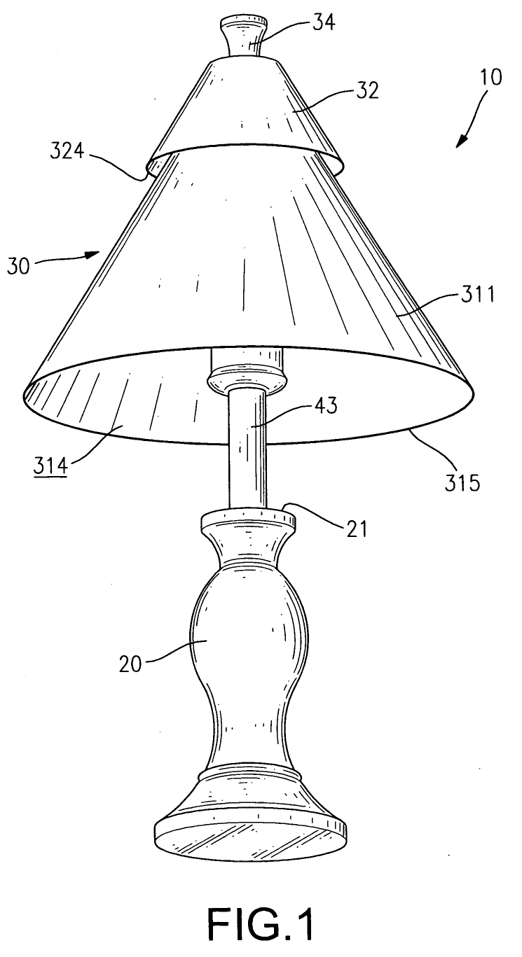

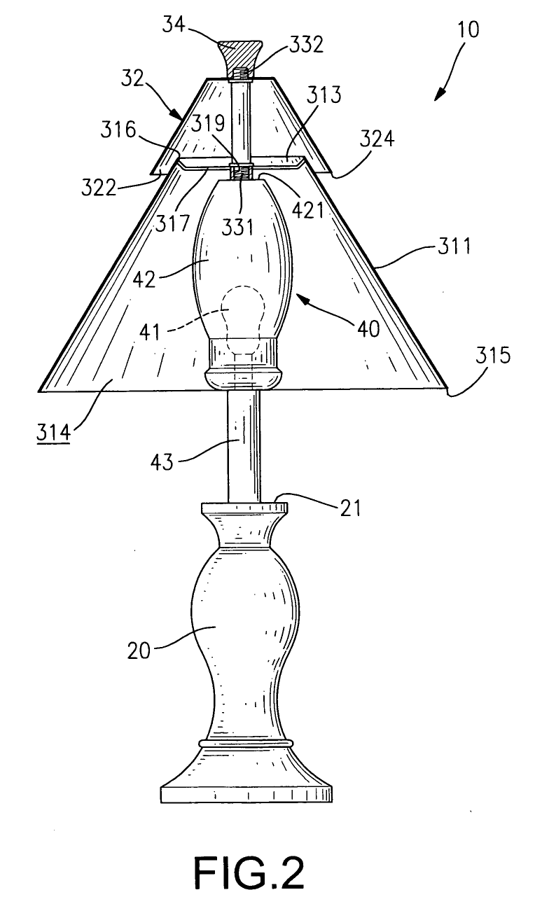

With reference to FIGS. 1 and 2, a precipitation-proof vented lamp (10) in accordance with the present invention comprises a base (20), a stacked shade assembly (30) and an illuminating device (40).

The base (20) has a mounting surface (21) on which the illuminating 22 device (40) is mounted.

The illuminating device (40) comprises a light bulb (41), a protective case (42) and a lamp mounting socket (43). The lamp mounting socket (43) is mounted on the mounting surface (21) of the base (20). The light bulb (41) is mounted on the lamp mounting socket (43) to produce light. The protective case (42) is mounted on the lamp mounting socket (43), covers the light bulb (41) inside and has a top surface (421).

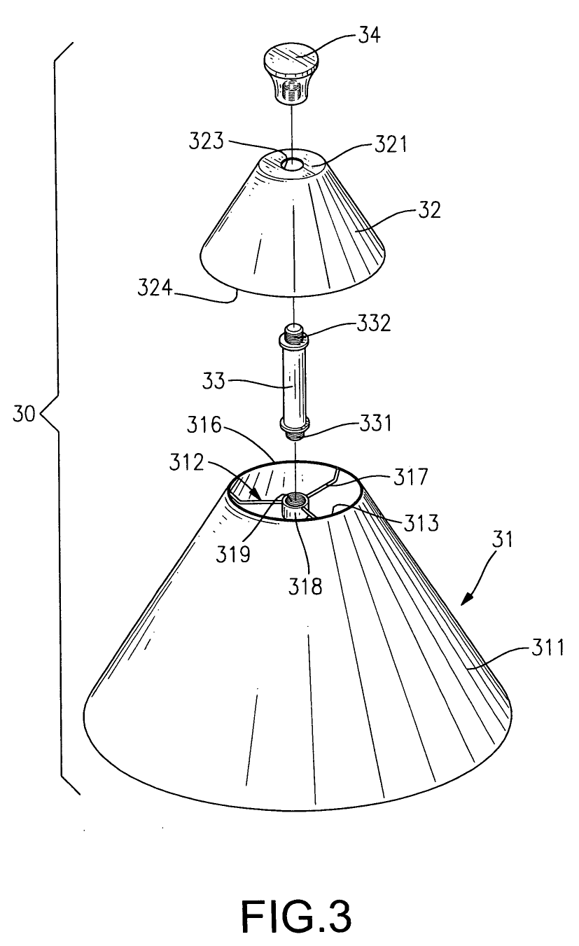

With further reference to FIG. 3, the stacked shade assembly (30) is attached to the top surface (421) of the protective case (42) and comprises a primary shade (31), a secondary shade (32), a connecting rod (33) and a fastener (34).

The primary shade (31) is attached to the top surface (421) of the protective case (42) and comprises a conical shade casing (311) and a mounting bracket (312). The shade casing (311) is made of waterproof materials, such as plastic and has a minor opening (313) and a first major opening (314). The first major opening (314) has a first major annular edge (315) mounted around and below the protective case (42). The minor opening (313) has a minor annular edge (316) mounted around and over the protective case (42).

The mounting bracket (312) is attached to the minor annular edge (316) and is held in the minor opening (313) and comprises multiple connecting ribs (317) and a socketjoint (318). The socketjoint (318) has a threaded hole (319). The connecting ribs (317) connect to the minor annular edge (316) and are united with the socket joint (318). The socket joint (318) is centrally positioned in the minor opening (313) and is attached to the top surface (421) of the protective case (42).

The secondary shade (32) is mounted on the mounting bracket (312) with the connecting rod (33), is conical and has a minor top (321) and a second major opening (322). The minor top (321) has a through hole (323) aligned with the threaded hole (319) in the socket joint (318). The second major opening (322) receives a segment of the shade casing (311) of the primary shade (31) and has a second major annular edge (324). The second major annular edge (324) in the secondary shade (32) overlaps the first minor annular edge (315) in the primary shade (31). Therefore, the precipitation will not enter the primary shade (31) through the minor opening (313), yet the minor opening (313) in the primary shade (31) allows air ventilation to dissipate the heat generated by the light bulb (41).

The connecting rod (33) has two threaded ends including a first threaded end (331) and a second threaded end (332). The first threaded end (331) screws into the threaded hole (319) in the socket joint (318). The second threaded end (332) extends through the through hole (323) in the secondary shade (32) onto which the fastener (34) screws to fasten the primary and the secondary shades (31, 32) together.

Consequently, the shades (31, 32) will prevent the precipitation entering the stacked shade assembly (30). Because the protective case (42) will become hot when the light bulb (41) is lit for a long time, the protective case (42) would be easily damaged to its materials if the rainwater directly dropped onto the hot protective case (42).

The heat generated by the light bulb (41) is efficiently dissipated through the minor opening (313) of the primary shade (31) and the second major opening (322) of the secondary shade (32) by air ventilation.

Since the protective case (42) is kept from direct exposure to rainwater, the entire outdoor light is durable. Furthermore, either disassembling or assembling the light bulb (41) is also convenient because of the first major opening (314) of the primary shade (31).

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

What is claimed is:

1. A precipitation-proof vented lamp comprising
a base having a mounting surface;
an illuminating device mounted on the mounting surface of the base;
a stacked shade assembly attached to the illuminating device and comprising
a primary shade attached to the illuminating device and comprising a shade casing and a mounting bracket mounted on the shade casing, and the shade casing having a minor opening with a minor annular edge;
a connecting rod mounted on the mounting bracket on the primary shade; and
a secondary shade mounted on the connecting rod and having a minor top connected to the connecting rod and a major opening receiving a segment of the shade casing of the primary shade and having a major annular edge;
wherein the major annular edge in the secondary shade overlaps the minor annular edge of the minor opening in the primary shade.

2. The precipitation-proof vented lamp as claimed in claim 1, wherein
the illuminating device comprises a lamp mounting socket mounted on the mounting surface of the base, a light bulb mounted on the lamp mounting socket to produce light, and a protective case with a top surface mounted on the lamp mounting socket to cover the light bulb inside; and
the primary shade is attached to the top surface of the protective case of the illuminating device.

3. The precipitation-proof vented lamp as claimed in claim 1, wherein
the mounting bracket is mounted on the minor annular edge in the primary shade and comprises multiple connecting ribs and a socket joint, the connecting ribs connect to the minor annular edge in the primary shade and are united with the socket joint and the socket joint has a threaded hole;
the minor top in the secondary shade has a through hole aligned with the threaded hole in the socket joint;
the connecting rod has a first threaded end screwing into the threaded hole in the socket joint and a second threaded end extending out of the through hole in the secondary shade; and
the stacked shade assembly further comprises a fastener screwing onto the second threaded end of the connecting rod to fasten the primary and the secondary shades.

4. The precipitation-proof vented lamp as claimed in claim 1, wherein the shade casing of the primary shade and the secondary shade are conical.
